(19) United States
(12) Patent Application Publication
(10) Pub. No.: US 2025/0125452 A1
(43) Pub. Date: Apr. 17, 2025

(54) BATTERY PACKS

(71) Applicant: Daylyte, Inc., Knoxville, TN (US)

(72) Inventor: Caleb Tyler Alexander, Knoxville, TN (US)

(21) Appl. No.: 18/988,395

(22) Filed: Dec. 19, 2024

Related U.S. Application Data
(63) Continuation-in-part of application No. PCT/US24/42965, filed on Aug. 19, 2024.
(60) Provisional application No. 63/533,620, filed on Aug. 19, 2023.
(60) Provisional application No. 63/612,285, filed on Dec. 19, 2023.
(60) Provisional application No. 63/560,913, filed on Mar. 4, 2024.

(51) Int. Cl. H01M 12/06; H01M 8/04029; H01M 8/0444; H01M 50/204; H01M 50/253; H01M 50/367; H01M 50/509; H01M 50/77

(52) U.S. Cl. CPC H01M 12/06; H01M 8/04029; H01M 8/04455; H01M 50/204; H01M 50/253; H01M 50/367; H01M 50/509; H01M 50/77

(57) ABSTRACT

Battery packs for a plurality of batteries are disclosed. The battery packs can be particularly suitable for metal-air batteries and can include channels for air and channels to replenish electrolyte. The battery packs can further include electronic circuitry to switch one or more batteries from series to parallel or parallel to series. The battery parks can recirculate the catholyte as cooling fluid. Methods of making and using the battery packs are further disclosed.

### CROSS-REFERENCE TO RELATED APPLICATIONS

This application n is a continuation-in-part of PCT application serial no. PCT/US2024/42965, filed Aug. 19, 2024, which claims the priority benefit of U.S. provisional patent application Ser. No. U.S. 63/533,620, filed Aug. 19, 2023. This application further claims the priority benefit of U.S. provisional patent application Ser. No. U.S. 63/560,913, filed Mar. 4, 2024, and U.S. provisional patent application Ser. No. U.S. 63/612,285, filed Dec. 19, 2023. Each of the foregoing applications is hereby incorporated by reference herein in their respective entireties.

### STATEMENT REGARDING FEDERALLY-SPONSORED RESEARCH

This invention was made with government support under DE-SC0022492 awarded by the Department of Energy. The government has certain rights in the invention.

### BACKGROUND

Battery cells have nominal voltages of about 1.5 volts to about 3.5 volts depending on the chemistry of the cell. To provide higher voltages or greater capacity, it is necessary to provide a battery pack containing a plurality of individual battery cells in series to increase voltage, in parallel to increase capacity, or a combination of series and parallel to increase both. While many applications only require simple battery packs that output voltages over a single range, battery packs for other applications, such as battery packs for automotives or airplanes, can require battery packs with greater functionality.

### SUMMARY

According to one embodiment, a battery pack including a plurality of metal-air batteries includes one or more of a) an air intake, air channels connected to the plurality of metal-air batteries, and an air output; b) an electrolyte intake, electrolyte channels connected to the plurality of metal-air batteries, and an electrolyte output; or c) one or more electronic circuits to switch a first subset of the batteries and a second subset of the batteries from a series connection to a parallel connection or a parallel connection to a series connection.

### BRIEF DESCRIPTION OF DRAWINGS

FIGS. 1A to 1D depict a top view, side views, and a cross-sectional view of a battery pack including air and water intakes and outputs.

FIG. 2 depicts an electronic circuit diagram enabling one or more batteries to be switched from series to parallel or parallel to series with a second set of one or more batteries.

### DETAILED DESCRIPTION OF THE BACKGROUND

As will be described herein, battery packs with improved functionality, safety, and longevity are disclosed. The battery packs can be suitable for grid scale applications, robotic applications, drones, automobiles, home energy storage, off-grid energy storage, and airplanes. While the battery packs disclosed herein are suitable for use with any type of secondary batteries, the disclosed battery packs are particularly suitable for metal-air batteries which replace the traditional cathode with an air cathode that can oxidize hydroxide and reduce atmospheric oxygen. Metal-air batteries offer numerous advantages over traditional battery chemistries but do require modifications for operation in a battery pack such as exposure to atmosphere. Additional details of exemplary metal-air batteries are disclosed in U.S. Patent App. Pub. No. 2023/0068006 A1, which is hereby incorporated by reference herein in its entirety.

The battery packs disclosed herein includes features designed to improve the operation of metal-air batteries including channels to provide oxygen to the individual metal-air batteries, channels to refresh electrolyte in the metal-air batteries, and electronic circuitry to dynamically switch individual batteries, or banks of batteries, from series to parallel or from parallel to series.

### Oxygen Channels

In contrast to traditional batteries which are substantially closed systems in normal operation, metal-air batteries require exposure to ambient oxygen to operate. Further, to improve the lifespan of a metal-air battery, such ambient oxygen needs to be free, or substantially free, of carbon dioxide which can detrimentally dissolve into the electrolyte to form carbonates which can cause permanent damage to the battery cell or reduce energy capacity.

The presently described battery packs overcomes such issues by providing an air intake and air channels in the battery packs that circulate oxygen to each metal-air battery that is free, or substantially free, of carbon dioxide. Although the battery packs can use any type of known carbon dioxide scrubber such as amine scrubbing, mineral or zeolite scrubbing, activated carbon scrubbing, the present battery packs can advantageously use metal hydroxide carbon dioxide scrubbers. Metal hydroxide carbon dioxide scrubbers operate by bubbling gas through a metal hydroxide solution, such as sodium hydroxide solution or lithium hydroxide solution, are highly economical, effective, and are particularly suited for the present application because such metal hydroxides can share commonality with the electrolyte in the metal-air battery packs. Such commonality simplifies consumables and cases maintenance compared to other types of carbon dioxide scrubbers.

In battery packs including a metal hydroxide carbon dioxide scrubber, each battery pack can include one or more air intakes leading to a bubbler filled with metal hydroxide solution. Inside the bubbler, the air can be injected into the solution and then bubble up through the solution before entering air channels in the battery pack leading to each of the metal-air batteries. The air channels can lead to an exhaust where the carbon-dioxide depleted air can exit the battery pack. In certain embodiments, the air exhaust exit can include a one-way valve to prevent atmosphere from drawing back into the battery without being scrubbed for carbon dioxide at the input. In certain embodiments, the one-way valve can be a bubbler filled with water, mineral-oil, or some other liquid (ideally having a low vapor-pressure).

As can be appreciated, similar battery packs can be formed with other known carbon dioxide scrubbers in various embodiments or use alternative compositions for the bubbler such as other strong bases.

In certain embodiments, oxygen meters or carbon dioxide meters can be included to alert an operator if the amount of oxygen or carbon dioxide contained within the battery pack is within an acceptable range. In certain embodiments, the battery pack can automatically disconnect the batteries within the battery pack if the amount of available oxygen or available carbon dioxide is outside of an acceptable range.

### Electrolyte Channels

In certain embodiments, the battery packs described herein can include one or more channels to allow filling or refilling of the electrolyte in each of the batteries. Although loss and/or degradation of battery electrolyte is rare in metal-air batteries, battery longevity can be increased be replacing the electrolyte with fresh electrolyte periodically or in response to contamination caused by, for example, carbon dioxide. In addition to filling electrolyte, the same channels can also be used to drain electrolyte from the batteries if the electrolyte is degraded.

In certain embodiments, the electrolyte channels can also be used for alternative battery chemistries. For example, if the battery pack is used with lead-acid batteries, the electrolyte channels can be used to replace sulfuric acid.

In certain embodiments, two sets of electrolyte channels can be provided for use with flow batteries. Flow batteries are batteries where the electric potential is stored in an anolyte and catholyte and each battery cell includes an ion-selective membrane to allow for charging and discharging. The battery packs described herein can enable flow batteries to output higher voltage by placing multiple flow batteries in series while negating the need to maintain separate anolyte and catholyte tanks.

Optionally, a pump can be included to recirculate the liquid from the output back to the liquid input. Such a pump can be used to balance the electrolyte in metal-air battery cells or can be used to pump analyte and catholyte in a flow battery. In certain embodiments, a valve can be used to enable the pump to drain the battery cells or replace electrolyte with only new electrolyte.

### Exemplary Battery Packs

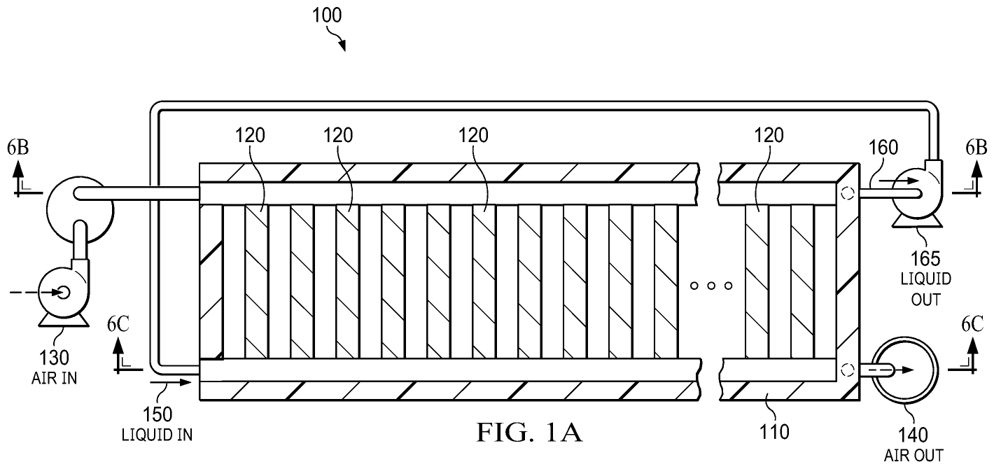

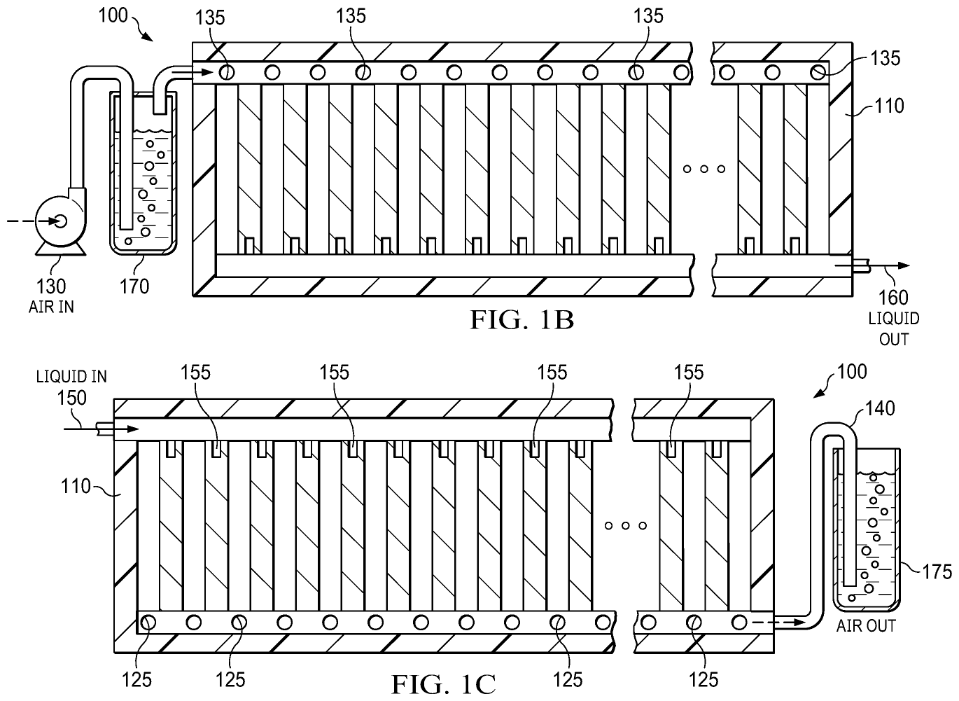

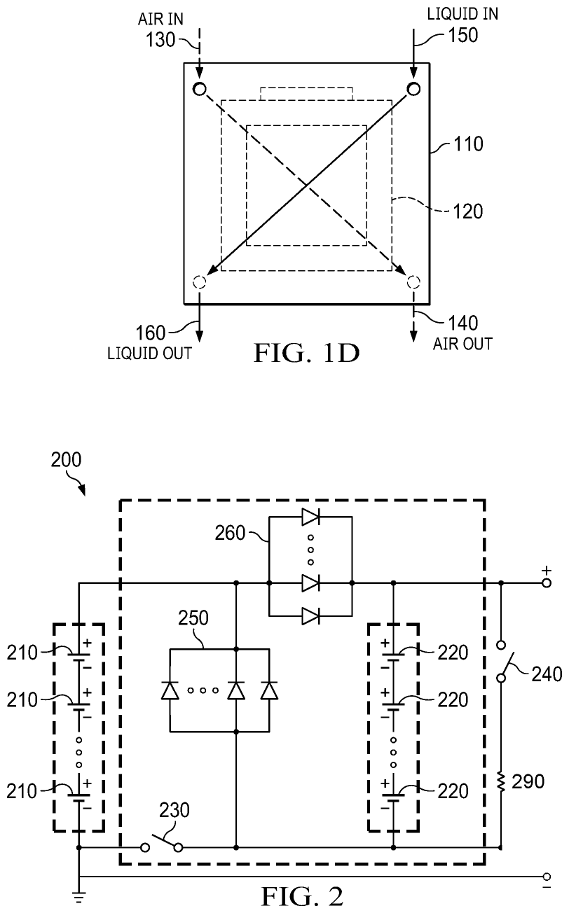

An exemplary battery pack as described herein is depicted in FIGS. 1A to 1D depicting a top view (FIG. 1A), side views (FIG. 1B and 1C) and a cross-sectional view (FIG. 1D).

As depicted, the battery pack 100 includes a housing 110, a plurality of batteries 120, an air intake 130, an air output 140, a liquid intake 150, and a liquid output 160. The battery pack 100 further includes a plurality of air channels 135 connecting the air intake 130 to each of the plurality of batteries 120 and eventually the air output 140. Similarly, the battery pack 100 can include a plurality of liquid channels 155 connecting the liquid intake 150 to each of the plurality of batteries 120 before exiting at the liquid output 160. As seen in FIG. 1D, the air intake 130 and air output 140 are on opposite corners of the battery pack 100 having the air channels 135 cross from one side of the battery pack 100 to the other side of the battery pack 100. The liquid channels 155 connecting the liquid input 150 and liquid output 160 similarly cross from one side of the battery pack 100 to the other side of the battery pack 100. The liquid output 160 can include a pump 165 to return liquid to the liquid input 150.

As depicted in the side views (FIGS. 1B and 1C), the air intake includes a carbon dioxide scrubber 170 at the air intake 130 that bubbles incoming air through a metal hydroxide solution to remove carbon dioxide. The air output 140 can include a bubbler 175 to prevent air entering the air channels 135 from the air output 140.

### Electronic Circuitry

The battery packs disclosed herein can further include electronic circuitry to switch individual batteries, or banks of batteries, from series to parallel or from parallel to series. As can be appreciated, such functionality can allow for numerous benefits. For example, by shifting battery cells to be in series, the voltage of the battery pack can be increased allowing for more efficient charging with less energy lost to waste heat. From Ohm's law and the Power Law, it can be determined that the waste energy lost as heat is equal to I²R. While R will remain constant for a battery pack, by increasing the voltage, the waste energy lost will be dramatically lowered for the same amount of energy being supplied to the battery. For example, merely doubling the voltage of the battery pack will cut the waste energy to a quarter as doubling the voltage cuts the current in half. However, some operations, such as motor torque, can benefit from higher current at lower voltages.

Accordingly, the battery packs disclosed herein can be dynamically shifted depending on the desired operation of the battery. For instance, during charging of the battery pack, higher voltages can be preferred while a lower voltage output can be used for discharge of the battery pack. Alternatively, the available charging voltage may be low necessitating that the battery pack be charged at a lower voltage than the desired discharge voltage.

Such voltage selection can also improve compatibility of the battery pack to use different voltage chargers. For instance, electric vehicle service equipment (“EVSE”) chargers can operate using a 400V architecture or 800V architecture. The battery packs disclosed herein can maximize their efficiency with each type of EVSE by shifting the voltage of the battery packs to match the optimal output of the EVSE.

FIG. 2 depicts an electronic circuit schematic for shifting one or more battery cells from series to parallel. As depicted, the electronic circuit 200 facilitates switching a first set of batteries 210 and a second set of batteries 220 from a series arrangement to parallel series arrangement with operation of switch 230 and switch 240. Two sets of parallel diodes 250 and 260 are included. The output of the combined batteries 210 and 220 is represented as a resistive load 290.

When switch 230 is open and switch 240 is open, the first set of batteries 210 and the second set of batteries 220 can operate in series with diodes 250 and 260 preventing a short circuit. In this mode, the battery pack charges at high voltage at a lower current. To operate the battery sets 210 and 220 in parallel mode operation and increase the current of the battery pack, switch 230 can be closed and switch 240 closed. Each set of batteries 210 and 220 can include one or more batteries.

As can be appreciated, a battery pack can include one set of electric circuitry as depicted in FIG. 2 or a plurality of similar circuits. When a plurality of such circuits are included, the battery pack can tie each set of switches together to enable placing of the entire battery pack in series or in parallel.

Additionally or alternatively, the battery pack can include a controller to selectively enable the switches to select a nominal pack voltage that maximizes the available capacity of the battery pack for the selected nominal voltage. In such operations, additional sets of the electronic circuits depicted in FIG. 2 can be provided to group together smaller subsets of batteries. For example, for a battery pack including 64 batteries, the batteries can be grouped into 16 groups of 4 batteries apiece with each group of 4 batteries including a set of electronic circuitry to switch those 4 batteries into series or parallel operation. Additional sets of electronic circuitry can then be used between the 16 groups to select between series and parallel operation. As can be appreciated, the design is easily scalable to an arbitrary number of batteries and can allow near arbitrary selection of nominal voltage for the overall battery pack.

### Cell Design and Cooling

In a typical metal-air battery pack, cells are assembled into modules and the modules into packs where the packs include thermal management systems to cool the individual cells and thermally isolate them to prevent thermal runaway from occurring. However, thermal management systems can add cost, complexity, and make it difficult to disassemble the pack for recycling.

In certain embodiments, a metal-air battery pack configuration is disclosed where the cells span the width of the pack and the catholyte is used as the liquid cooling medium to improve heat transfer and mass transfer rates. In such embodiments, the battery pack can be simpler and have a higher power output and density. Generally, the catholyte can be cooled by a heat exchanger and recirculated by a recirculating pump. The heat exchanger can be placed anywhere on the pack as long as the catholyte will pass by it.

In certain such embodiments, the heat exchanger can be located beneath the battery pack because, if the pack were powering a vehicle, the pack would likely be stored in the bottom of the vehicle (for a lower center of mass) so the heat exchanger could use the flowing air from the moving vehicle to remove heat. Because the catholyte inside the battery cells is the cooling medium, heat transfer is improved. Additionally, as the recirculating pump is circulating the catholyte and effectively stirring the solution, it will increase mass transfer rates within the battery thereby shrinking the solution resistance (which becomes significant with thick electrodes) to enable a higher power battery.

Using the catholyte as the coolant will further create a catholyte reservoir by the heat exchanger thereby enabling the oxygen reduction reaction (ORR) electrode to be placed nearer to the negative electrode. As can be appreciated, this will lower the solution resistance for higher power. Additionally, if/when there is significant volume expansion for the negative electrode, the heat exchanger (and thus the catholyte reservoir) is optimally on the battery pack sides or on top so as the catholyte level rises and falls then the electrodes remain covered with catholyte for uniform electrode performance. In certain embodiments, the catholyte reservoir could alternatively be held separate from the rest of the battery pack.

### Additional Battery Pack Features

In certain embodiments, various other features can be included in the battery pack. For example, one or more ohmmeters and voltmeters can detect whether the current and voltage of the battery pack as a whole, or within individual batteries, is within acceptable values. In certain embodiments, the battery pack can automatically disconnect the batteries or limit the voltage, or current, to restore the batteries back to the designed operating condition.

Additionally, in certain embodiments, the battery pack can include a battery controller that can optionally include traces to individual batteries within the battery pack. As can be appreciated, to maintain the lifespan of the battery pack, each of the batteries inside the pack needs to be maintained at substantially the same charging level. In certain such embodiments, the battery controller can address each of the batteries within the battery pack to ensure that the charge level of each battery is matched to the other batteries. In certain embodiments, the battery controller can individually charge specific batteries to bring batteries to the appropriate charge level. Additionally, the battery controller can monitor the incoming and outgoing voltages and currents for appropriate charging and discharging. For example, the battery controller can ensure that the batteries follow the appropriate charging curve for the included battery and do not damage any of the batteries.

As can be appreciated, the battery pack can include yet other optional features in various embodiments. For example, the battery pack can include an AC to DC rectifier to enable charging of the battery pack using incoming AC voltage, or include a DC to AC inverter to output alternating current for energy storage applications.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

It should be understood that certain aspects, features, structures, or characteristics of the various embodiments can be interchanged in whole or in part. Reference to certain embodiments mean that a particular aspect, feature, structure, or characteristic described in connection with certain embodiments can be included in at least one embodiment and may be interchanged with certain other embodiments. The appearances of the phrase “in certain embodiments” in various places in specification are not necessarily all referring to the same embodiment, nor are certain embodiments necessarily mutually exclusive of other certain embodiments. It should also be understood that the steps of the methods set forth herein are not necessarily required to be performed in the orders described, and the order of the steps of such methods should be understood to be merely exemplary. Likewise, additional steps can be included in such methods, and certain steps may be omitted or combined, in methods consistent with certain embodiments.

What is claimed is:

1. A battery pack including a plurality of metal-air batteries comprising one or more of:
a) an air intake, air channels connected to the plurality of metal-air batteries, and an air output;
b) an electrolyte intake, electrolyte channels connected to the plurality of metal-air batteries, and an electrolyte output; or
c) one or more electronic circuits to switch a first subset of the batteries and a second subset of the batteries from a series connection to a parallel connection or a parallel connection to a series connection.

2. The battery pack of claim 1, wherein the air intake comprises a carbon dioxide scrubber.

3. The battery pack of claim 2, wherein the carbon dioxide scrubber comprises a metal hydroxide bubbler.

4. The battery pack of claim 3, wherein the metal hydroxide comprises sodium hydroxide.

5. The battery pack of claim 1, wherein the air output comprises a one-way valve.

6. The battery pack of claim 5, wherein the one-way valve is a water, mineral oil or other liquid bubbler.

7. The battery pack of claim 1, further comprising one or more oxygen meters and carbon dioxide meters.

8. The battery pack of claim 1, further comprising a pump to recirculate the electrolyte output back to the electrolyte input.

9. The battery pack of claim 1, further comprising a second electrolyte intake, a second set of electrolyte channels, and a second electrolyte output.

10. The battery pack of claim 1, wherein the electronic circuits comprise a first switch, a second switch, and a first set of diodes, and a second set of diodes.

11. The battery pack of claim 1 comprising a plurality of electronic circuits.

12. The battery pack of claim 1, further comprising a plurality of additional electronic circuits to switch supersets of batteries from a series connection to a parallel connection or a parallel connection to a series connection.

13. The battery pack of claim 1, wherein each of the plurality of metal-air batteries comprise a sodium-air battery.

14. The battery pack of claim 1, further comprising a battery charge controller.

15. The battery pack of claim 1, further comprising a recirculating pump and a heat exchanger.

16. The battery pack of claim 15, wherein the catholyte is the cooling medium.
